(19) United States
(12) Patent Application Publication
(10) Pub. No.: US 2026/0301084 A1
(43) Pub. Date: Oct. 1, 2026

(54) POWER TRANSACTION MATCHING APPARATUS, POWER TRANSACTION MATCHING SYSTEM, AND POWER TRANSACTION MATCHING METHOD

(71) Applicant: HONDA MOTOR CO., LTD., Tokyo (JP)

(72) Inventors: Toru Kimura, Offenbach am Main (DE); Martin Kopp, Offenbach am Main (DE); Christian Koebel, Offenbach am Main (DE)

(21) Appl. No.: 19/542,692

(22) Filed: Feb. 18, 2026

(30) Foreign Application Priority Data
Mar. 28, 2025 (JP) 2025-056968

(51) Int. Cl. G06Q 50/06

(52) U.S. Cl. CPC G06Q 50/06

(57) ABSTRACT

A power transaction matching apparatus matching power transactions between a plurality of power systems individually generating and/or consuming electric power, the power transaction matching apparatus including: a first information acquisition part acquiring power sale requests from the power systems of a power selling-side; a second information acquisition part acquiring power purchase requests from the power systems of a power purchasing-side; and a calculation part calculating achievement levels of trading conditions for electric power to be traded on the basis of power sellable conditions, which are trading conditions of the power sale request, and desired power purchase conditions, which are trading conditions of the power purchase request.

### CROSS-REFERENCE TO RELATED APPLICATION

This application claims priority to Japanese Patent Application No. 2025-056968 filed on Mar. 28, 2025, the entire contents of which are incorporated by reference herein.

### BACKGROUND OF THE INVENTION

The present invention relates to a power transaction matching apparatus, a power transaction matching system, and a power transaction matching method.

In recent years, research and development relating to renewable energy that contributes to improving energy efficiency has been performed in order to enable more people to secure access to affordable, reliable, sustainable, and advanced energy. For this reason, in recent years, for example, the introduction of renewable energy power generation systems using power generation facilities installed in residences and the like has been promoted. In technologies relating to renewable energy, it is conceivable that more electric power may be generated than the amount of electric power used (consumed) in a residence. In other words, it is conceivable that the generated renewable energy may be surplus (become surplus power). For this reason, trading of surplus power of generated renewable energy (exchange of electric power) is also performed among individuals.

In relation to this, a technology relating to a power transaction matching system that performs matching between users when electric power is traded among individuals has been disclosed (for example, Japanese Unexamined Patent Application, First Publication No. 2023-150729). In the conventional technology, a technology in which sales reason information relating to reasons or purposes for trading electric power is collected from power-selling sides and power-buying sides, user systems of the power-selling side and user systems of the power-buying side are categorized on the basis of the trading reason information, a user system group is divided into a plurality of balancing groups, and thus the amount of power to be traded and the trading price are appropriately determined with the reasons or purposes for which users of the power-selling side wish to sell electric power and the reasons or purposes for which users of the power-buying side wish to purchase electric power sufficiently reflected, has been disclosed. Here, in the conventional technology, as reasons for which users of the power-buying side wish to purchase electric power, for example, desired electric power may be selected on the basis of rating information of power plants, and the purchase price may be changed on the basis of the rating. At that time, users of the power-buying side may set filtering conditions, and it has been disclosed that “a maximum purchase price,” “must-have,” “a power source ratio”, and the like may be set as the reasons. On the other hand, as reasons for which user of the power-selling side wish to sell electric power, conditions for selling may be set on the basis of corporate ratings, and it has been disclosed that the company's social contribution, initiatives toward environmental issues, SDGs, and the like may be set as the reasons.

### SUMMARY OF THE INVENTION

However, in the conventional technology, user systems of the power-selling side and user systems of the power-buying side are categorized on the basis of one piece of sales reason information, and a process performed in a case in which multiple conditions (reasons for purchasing electric power and reasons for selling electric power) are set as requests for trading has not been reviewed. For this reason, in the conventional technology, it is conceivable that it becomes more difficult to perform matching between users as there are a plurality of conditions set in individual requests for trading electric power.

An aspect of the present invention provides a power transaction matching apparatus, a power transaction matching system, and a power transaction matching method that can enable more appropriate trading partners to be found when electric power is bought and sold among individuals. An aspect of the present invention contributes to improving energy efficiency.

A power transaction matching apparatus, a power transaction matching system, and a power transaction matching method according to the present invention employ the following configurations.
(1): A power transaction matching apparatus according to one aspect of the present invention is a power transaction matching apparatus matching power transactions between a plurality of power systems individually generating and/or consuming electric power, the power transaction matching apparatus including: a first information acquisition part acquiring power sale requests from the power systems of a power selling-side; a second information acquisition part acquiring power purchase requests from the power systems of a power purchasing-side; and a calculation part calculating achievement levels of trading conditions for electric power to be traded on the basis of power sellable conditions, which are trading conditions of the power sale request, and desired power purchase conditions, which are trading conditions of the power purchase request.
(2): In the aspect (1) described above, the power sellable conditions include, at least, trading conditions for each of items including a power sellable time period that is an item of a time period, a sellable power amount that is an item of a power amount, and a power sellable price that is an item of a price, the desired power purchase conditions include, at least, the trading conditions of each of items including a desired power purchase time period that is an item of a time period, a desired power purchase amount that is an item of a power amount, and a desired power purchase price that is an item of a price, and the calculation part calculates the achievement level for each of the items of the trading conditions and presents a sum value of the achievement levels of each of the items as a matching result.
(3): In the aspect (2) described above, a search part searching for candidates matching the power sale request and the power purchase request is further included, and the calculation part presents the matching result between the retrieved power sale request and the power purchase request.
(4): In the aspect (3) described above, in a case in which the matching result representing the power purchase request to be recommended for the power sale request is presented, the calculation part calculates a first achievement level that is an achievement level of the sellable power amount with respect to an upper limit value of the desired power purchase amount and a second achievement level that is an achievement level of the sellable power price with respect to an upper limit value of the desired power purchase price and presents the power purchase request for which a sum value of the first achievement level and the second achievement level is high as the matching result, and in a case in which the matching result representing the power sale request to be recommended for the power purchase request is presented, the calculation part calculates a third achievement level that is an achievement level of the desired power purchase amount with respect to an upper limit value of the sellable power amount and a fourth achievement level that is an achievement level of the sellable power price with respect to an upper limit value of the desired power purchase price and presents the power sale request for which a sum value of the third achievement level and the fourth achievement level is high as the matching result.
(5): In the aspect (4) described above, either one or both of the power sellable conditions and the desired power purchase conditions further include priority order conditions for each of the items of the trading conditions, and the calculation part calculates a final achievement level for each of the items by multiplying the calculated achievement level of each of the items of the trading conditions by a weighting coefficient that is set in advance for the priority order conditions and presents the power sale request and the power purchase request for which a sum value of the final achievement levels of each of the items is high as the matching result.
(6): In the aspect (5) described above, the priority order conditions include at least one of a first condition prioritizing the item of the power amount, a second condition prioritizing the item of the price, and a third condition prioritizing a balance between the item of the power amount and the item of the price.
(7): In the aspect (6) described above, the first condition includes a 1-1 condition in which the priority of the item of the power amount is higher and a 1-2 condition in which the priority of the item of the power amount is high, and the second condition includes a 2-1 condition in which the priority of the item of the price is higher and a 2-2 condition in which the priority of the item of the price is high.
(8): In the aspect (7) described above, the priority order conditions further include a fourth condition of an origin of electric power to be traded.
(9): In the aspect (8) described above, the priority order conditions further include a fifth condition relating to a payment method in a power transaction.
(10): In any one of the aspects (1) to (9) described above, a reception part receiving a matching request between the power sale request and the power purchase request for which the sum value of the achievement levels has been presented as the matching result is further included, and the reception part performs requested matching between the power sale request and the power purchase request in accordance with the received matching request.
(11): A power transaction matching system according to one aspect of the present invention is a power transaction matching system that matches power transactions between a plurality of power systems individually generating and/or consuming electric power, the power transaction matching system including: a power transaction matching apparatus including: a first information acquisition part acquiring power sale requests from the power systems of a power selling-side; a second information acquisition part acquiring power purchase requests from the power systems of a power purchasing-side; and a calculation part calculating achievement levels of trading conditions for electric power to be traded on the basis of power sellable conditions, which are trading conditions of the power sale request, and desired power purchase conditions, which are trading conditions of the power purchase request; and a plurality of request devices corresponding to each of the power systems and transmitting the power sale request or the power purchase request to the power transaction matching apparatus.
(12): In the aspect (11) described above, one or more of the plurality of power systems are batteries mounted on vehicles.
(13): A power transaction matching method according to one aspect of the present invention is a power transaction matching method of a power transaction matching apparatus matching power transactions between a plurality of power systems individually generating and/or consuming electric power, the power transaction matching method using a computer of the power transaction matching apparatus including: acquiring power sale requests from the power systems of a power selling-side; acquiring power purchase requests from the power systems of a power purchasing-side; and calculating achievement levels of trading conditions for electric power to be traded on the basis of power sellable conditions, which are trading conditions of the power sale request, and desired power purchase conditions, which are trading conditions of the power purchase request.

According to the aspects (1) to (13) described above, it is possible to enable more suitable trading partners to be found when electric power is bought and sold among individuals.

### BRIEF DESCRIPTION OF THE DRAWINGS

FIG. 1 is a diagram illustrating an example of the configuration of a power transaction matching apparatus according to an embodiment and an example of a usage environment of a power transaction matching system including the power transaction matching apparatus.

FIG. 2 is a diagram illustrating an example in which a request to the power transaction matching apparatus according to the embodiment is input by a terminal device.

FIG. 3 is a functional block diagram illustrating an example of the configuration of a terminal device according to the embodiment.

FIG. 4 is a diagram schematically illustrating an example of a case in which an achievement level for a power sale request is calculated in the power transaction matching apparatus according to the embodiment.

FIG. 5 is a diagram schematically illustrating an example of a case in which an achievement level for a power purchase request is calculated in the power transaction matching apparatus according to the embodiment.

FIG. 6 is a flowchart illustrating an example of a flow of a matching process in the power transaction matching apparatus according to the embodiment.

### DETAILED DESCRIPTION OF THE INVENTION

Hereinafter, a power transaction matching apparatus, a power transaction matching system, and a power transaction matching method according to an embodiment of the present invention are described with reference to the drawings.

### Overall Configuration of Power Transaction Matching System

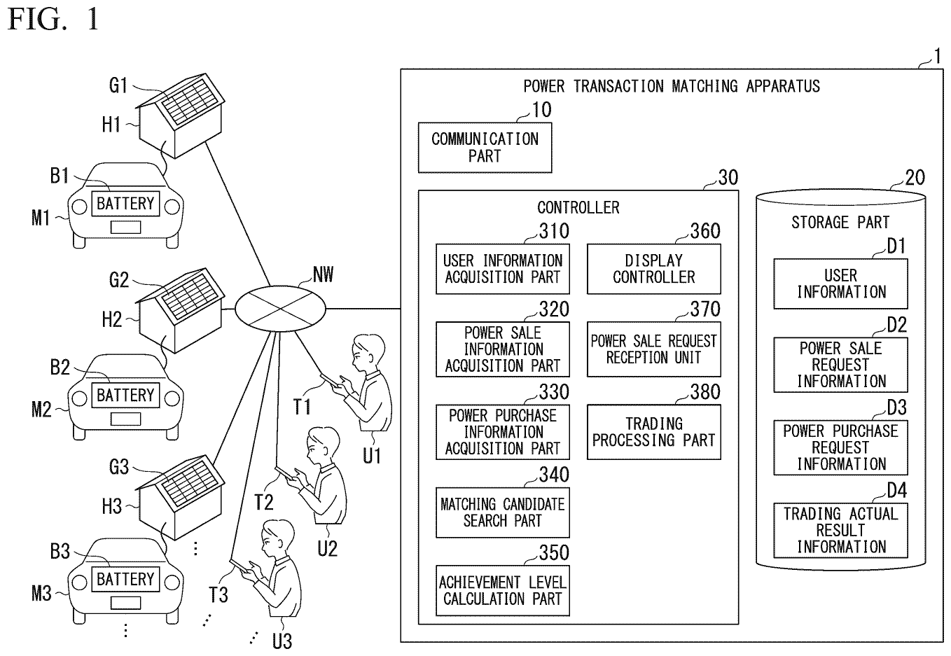

FIG. 1 is a diagram illustrating an example of the configuration of a power transaction matching apparatus according to an embodiment and an example of a usage environment of a power transaction matching system including the power transaction matching apparatus. A power transaction matching system S is a system that, for example, when electric power of renewable energy generated by power generation facilities installed at individual residences (individual houses) and the like of individuals (users) is traded among users, matches the users by presenting (introducing) users whose trading conditions are appropriate in consideration of respective conditions (trading conditions) of users of the power-selling side and users of the power-buying side. A power generation facility installed at the individual residence of a user is, for example, a photovoltaic power generation system. The electric power traded among users is not limited to electric power of renewable energy generated by a photovoltaic power generation system, and may include, for example, electric power of renewable energy generated by a power generation facility installed at an individual residence of a user that utilizes wind power or geothermal energy or electric power stored in a storage battery (hereinafter referred to as a “battery”) mounted on a vehicle owned (used) by the user.

The power transaction matching system S includes, for example, a power transaction matching apparatus 1, one or more power generation systems G, and one or more terminal devices T. FIG. 1 illustrates an example of the power transaction matching system S that matches trading of electric power performed among three users U (more specifically, among three power generation systems G (power generation systems G1 to G3) respectively installed at three individual residences H (individual residences H1 to H3)). The power generation system G stores generated electric power, for example, in a storage battery or the like and discharges the electric power stored in the storage battery when electric power is used at an individual residence H in which the power generation system G is installed. The power transaction matching apparatus 1, the individual residence H (more specifically, the power generation system G), and the terminal device T, which constitute the power transaction matching system S, are communicably connected to one another via a network NW. The network NW is, for example, an arbitrary network such as the Internet, a mobile communication network, a Wide Area Network (WAN), a Local Area Network (LAN), a cellular network, or the like. In a case in which electric power is traded between matched users U, the power generation systems G of the individual residences H of the users U exchange (transmit) electric power with each other, for example, via a power transmission path not illustrated in the drawing. The power transmission path not illustrated in the drawing is, for example, a transmission path installed by an electric utility company (a transmission and distribution operator, a retail electric power provider, or the like) not illustrated in the drawing.

The power transaction matching system S may include one or more vehicles M. FIG. 1 illustrates three vehicles M (vehicles M1 to M3) owned by users U who are residents of respective individual residences H. Each vehicle M is an electric vehicle (EV) that travels using an electric motor driven by electric power supplied from a battery B for traveling that is a secondary battery. The vehicle M is not limited to a four-wheeled vehicle and includes, in general, vehicles that travel using an electric motor driven by electric power supplied from the battery B such as saddle-type two-wheeled vehicles, three-wheeled vehicles (including both vehicles having one front wheel and two rear wheels and vehicles having two front wheels and one rear wheel), and assist-type bicycles. The vehicle M may be any vehicle as long as it is a vehicle that at least stores electric power supplied through a charging/discharging facility, which is not illustrated in the drawing, in the battery B. In other words, the vehicle M is not limited to a battery electric vehicle (BEV) and may be, for example, a vehicle such as a hybrid electric vehicle (HEV) that travels by further combining electric power supplied from the battery B with electric power supplied by operating an internal combustion engine such as a diesel engine or a gasoline engine that uses fuel as an energy source. For example, by connecting each vehicle M to a charging/discharging facility, which is not illustrated in the drawing, installed at a belonging individual residence H (by fitting a charging plug of the charging/discharging facility into a charging port of the vehicle M), the mounted battery B (batteries B1 to B3) is charged. The charging/discharging facility that is not illustrated charges the battery B with electric power of grid energy supplied from a power system (it may be a commercial power source) via a general distribution line network or electric power of renewable energy generated by a power generation system G installed at an individual residence H. In a case in which the user U trades electric power stored in the battery B, the charging/discharging facility not illustrated causes the battery B to discharge and transmits the electric power through the power generation system G or a power transmission path that is not illustrated.

In the following description, the power transaction matching apparatus 1 is assumed to perform power transactions among power generation systems G installed in individual residences H (more specifically, for example, among storage batteries that store electric power generated by the power generation systems G), and this is described as “trading of electric power among users U.”

The power generation system G is an example of a “power system.” A storage battery (battery B) mounted on a vehicle M is also an example of a “power system.”

The power transaction matching apparatus 1 performs overall control when matching the trading of electric power among users U who use the power transaction matching system S. Details of the power transaction matching apparatus 1 are described below.

The terminal device T is used, for example, by a user U. The terminal device T is a portable terminal device such as a smartphone or a tablet terminal. The terminal device T may also be, for example, a general-purpose personal computer (PC). The terminal device T performs procedures for enabling users U to perform power transactions (trading) in accordance with an operation performed by the user U. By executing an application for performing power transactions (hereinafter referred to as a “power transaction application”) that has been installed in advance, the terminal device T realizes various functions for trading electric power among users U.

When a power transaction service is used, a user U enrolls (registers) in advance in the power transaction service by using the power transaction application. When enrolling in the power transaction service, the user U operates the terminal device T, for example, to input information for identifying the user U such as a name, a gender, a date of birth, and a home address, and the like to the power transaction application. When enrolling in the power transaction service, the user U who uses the power transaction service may further input information of the origin of electric power, for example, indicating whether the electric power to sell is so-called electric power of clean energy such as electric power of renewable energy generated by solar light or electric power generated by a fuel cell (for example, a hydrogen fuel cell) mounted on a vehicle M to the power transaction application. Then, the power transaction application transmits user information associated with input information of the user U and the origin of electric power to the power transaction matching apparatus 1 via a network NW. At this time, the power transaction application, for example, may also transmit identification information used for identifying the terminal device T such as a terminal device ID to the power transaction matching apparatus 1 via a network NW. In accordance with this, the enrollment of the user U in the power transaction service is completed, and, for example, a user ID is assigned. Thereafter, a user U who is able to sell electric power (sell power), for example, logs in to the power transaction application using the assigned user ID and inputs a request or reservation for selling power (hereinafter referred to as a “power sale request”) to the logged-in power transaction application together with power sellable conditions such as a time period during which electric power can be sold (it may include a date or a period), an amount of electric power, and a price. In accordance with this, the power transaction application transmits information of the power sale request (hereinafter referred to as “power sale request information”) that has been input to the power transaction matching apparatus 1 via the network NW. On the other hand, a user U who desires to purchase electric power (buy power), for example, logs in to the power transaction application using the assigned user ID and inputs a request or a reservation for purchasing electric power (hereinafter referred to as a “power purchase request”) to the logged-in power transaction application together with desired power purchase conditions such as a desired time period (it may include a date or a period), a power amount power, and a price for purchasing power. In accordance with this, the power transaction application transmits information of the power purchase request (hereinafter referred to as “power purchase request information”) that has been input to the power transaction matching apparatus 1 via the network NW.

The terminal device T is an example of a “request device.”

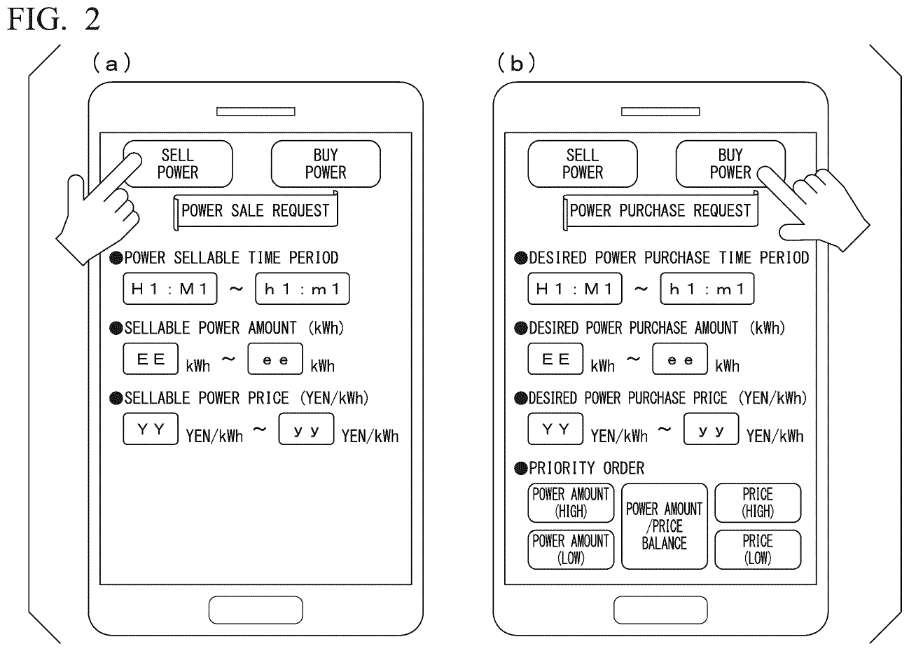

Here, an example of a case in which a power sale request or a power purchase request is input to the terminal device T is described. FIG. 2 is a diagram illustrating example in which a request to the power transaction matching apparatus 1 according to the embodiment is input by the terminal device T. Part (a) of FIG. 2 illustrates an example of a case in which a power sale request is input, and part (b) of FIG. 2 illustrates an example of a case in which a power purchase request is input.

The user U can input a power sale request by performing an operation of touching or tapping a “Sell Power” button displayed on the display device of the terminal device T using the power transaction application. On a power sale request input screen, input areas for each of items of “power sellable time period,” “power sellable amount of electric power (kWh),” and “power sellable price (yen/kWh)” are provided. Here, in a case in which the item of “power sellable time period” includes a date or a period, an item of “date (period)”, which is not illustrated in the drawing, is provided in the input area of the “power sellable time period.” Then, the user U performs an operation of touching or tapping the input area of each of items of “power sellable time period,” “power sellable amount of electric power (kWh),” and “power sellable price (yen/kWh)” within the power sale request input screen. In accordance with this, for example, a selection screen or a keyboard screen (it may be a numeric keypad (ten-key) screen), which is not illustrated in the drawing, is displayed through a pop-up. By operating the input screen displayed here, the user U can input power sellable conditions such as a time period during which power can be sold, an amount of electric power, and a price.

The user U can input a power purchase request by performing an operation of touching or tapping a “Buy Power” button displayed on the display device of the terminal device T using the power transaction application. On a power purchase request input screen, an input area of each of items of “desired power purchase time period,” “desired power purchase amount (kWh),” and “desired power purchase price (yen/kWh)” is provided. Here, in a case in which the item of “desired power purchase time period” includes a date or a period, an item of “date (period)”, which is not illustrated in the drawing, is provided in the input area for the “desired power purchase time period.” Then, the user U performs an operation of touching or tapping the input area for each of the items of “desired power purchase time period,” “desired power purchase amount (kWh),” and “desired power purchase price (yen/kWh)” within the power purchase request input screen. In accordance with this, for example, a selection screen or a keyboard screen (it may be a numeric keypad (ten-key) screen), which is not illustrated in the drawing, is displayed through pop-up. By operating the input screen displayed here, the user U can input desired power purchase conditions such as a time period during which power is desired to be purchased, an amount of electric power, and a price.

In the example illustrated in part (b) of FIG. 2, an example of the power purchase request input screen configured such that an item of “priority order” used for selecting prioritized desired power purchase conditions among the desired power purchase conditions is provided. More specifically, an example of the power purchase request input screen on which an “Electric Power Amount (High)” button, an “Electric Power Amount (Low)” button, an “Electric Power Amount/Price Balance” button, a “Price (High)” button, and a “Price (Low)” button are displayed is illustrated. The “Electric Power Amount (High)” button is a selection button selected in a case in which the satisfaction of the electric power amount is the most prioritized among the desired power purchase conditions. The “Electric Power Amount (Low)” button is a selection button selected in a case in which satisfaction of the electric power amount among the desired power purchase conditions is prioritized as much as possible, and the priority is lower than that of the “Electric Power Amount (High)” button. The “Price (High)” button is a selection button selected in a case in which the satisfaction of the power purchase price is prioritized the most among the desired power purchase conditions. The “Price (Low)” button is a selection button selected in a case in which the satisfaction of the power purchase price is prioritized as much as possible among the desired power purchase conditions, and the priority is lower than that of the “Price (High)” button. The “Electric Power Amount/Price Balance” button is a selection button selected in a case in which securement of a balance (a good balance is maintained) between the electric power amount and the power purchase price is prioritized. By performing an operation of touching or tapping any one of selection buttons according to a user's desire, the user U can designate a desired power purchase condition that is prioritized when using a power transaction service is used. In a case in which there is no desire for a prioritized desired power purchase condition, the user U may not select (designate) the item of “priority order.”

In the example illustrated in part (b) of FIG. 2, although a case in which five items including “Electric Power Amount (High),” “Electric Power Amount (Low),” “Electric Power Amount/Price Balance,” “Price (High),” and “Price (Low)” are provided as items of the “priority order” is illustrated, the number of items of the “priority order” is not limited to five as described above. For example, the number of the items may be three including “Electric Power Amount Priority,” “Electric Power Amount/Price Balance,” and “Price Priority,” may be at least one thereof, or may be seven including “Electric Power Amount (High),” “Electric Power Amount (Medium),” “Electric Power Amount (Low),” “Electric Power Amount/Price Balance,” “Price (High),” “Price (Medium),” and “Price (Low).”

On the power sale request input screen illustrated in part (a) of FIG. 2, although an example of a configuration in which the item of “priority order” is not provided is illustrated, the item of “priority order” may be provided also in the power sale request input screen. In this case, by performing an operation of touching or tapping any one of the selection buttons according to a user's desire, the user U can designate a power sellable condition that is prioritized when the power transaction service is used. In a case in which there is no desired power sellable condition to be prioritized, the user U may not select (designate) the item of “priority order.”

The items for which the user U selects (designates) a priority order are not limited to the above-described trading conditions (items such as a time period (it may include a date or a period), an electric power amount, and a price). For example, the items for which the user U selects (designates) a priority order may include items relating to the origin of the power such as whether or not the power is electric power of clean energy power and items relating to methods of receiving or giving payment at the time of using a power transaction service such as whether or not non-cash payment (so-called cashless payment) using a credit card being able to be used.

The item of “priority order” is an example of a “priority order condition.” “Electric Power Amount (High)” and “Electric Power Amount (Low)” are examples of “first condition,” “Electric Power Amount (High)” is an example of “1 -1 condition,” and “Electric Power Amount (Low)” is an example of “1-2 condition.” “Price (High)” and “Price (Low)” are examples of “second condition,” “Price (High)” is an example of “2-1 condition,” and “Price (Low)” is an example of “2 -2 condition.” “Electric Power Amount/Price Balance” is an example of “third condition.” The items relating to the origin of electric power are examples of “fourth condition.” The items relating to the methods of receiving and giving payment at the time of using a power transaction service are examples of “fifth condition.”

In the power transaction matching system S, the method of the user U's inputting a power sale request or a power purchase request to the terminal device T is not limited to the method illustrated in FIG. 2, and any method may be used as long as it is a method enabling the user U to input each request to the terminal device T. Since the present invention mainly focuses on procedures (matching procedures) for inquiring about users U who are capable of selling electric power (hereinafter referred to as “power selling-side users U”) and users U who desire to buy electric power (hereinafter referred to as “power buying-side users U”), further detailed descriptions of the method for enrolling users U in the power transaction service, the method for generating a power sale request (including a method for reserving power sales), and the method for generating a power purchase request (including a methods for reserving power purchases) are omitted.

The power transaction application presents (introduces) users whose trading conditions at the time of trading electric power are appropriate to the user U by causing a display device to display an image based on information transmitted from the power transaction matching apparatus 1. Each of these various functions may be realized using a general-purpose application program such as a web browser operating on the terminal device T. FIG. 1 illustrates three terminal devices T (terminal devices T1 to T3) used by users U (users U1 to U3) who are residents of individual residences H1 to H3. The terminal device T1 is used by the user U1, who is a resident of the individual residence H1 (and also the owner (user) of the vehicle M1), to perform procedures for using the power transaction service. Similarly, the terminal device T2 is used by the user U2, who is a resident of the individual residence H2 (and also the owner (user) of the vehicle M2), and the terminal device T3 is used by the user U3, who is a resident of the individual residence H3 (and also the owner (user) of the vehicle M3), to perform procedures for using the power transaction service.

### Configuration of Terminal Device

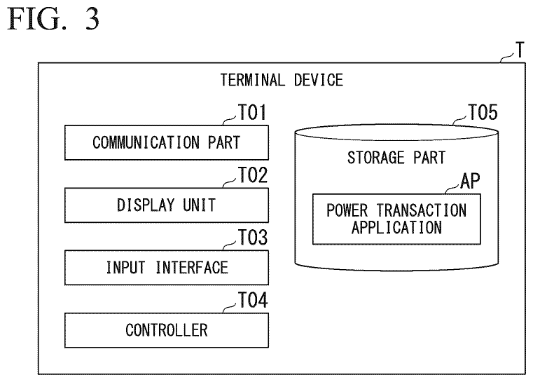

FIG. 3 is a functional block diagram illustrating an example of the configuration of the terminal device T according to the embodiment. The terminal device T includes, for example, a communication part T01, a display unit T02, an input interface T03, a controller T04, and a storage part T05. In FIG. 2, although illustration of other components that realize functions not relating to functions for performing procedures for conducting a transaction of (trading) electric power in response to operations performed by the user U in the terminal device T is omitted, the components included in the terminal device T are not limited to the above-described components, and other components may be included. For example, the terminal device T may include components such as an output interface for notifying the user U of various kinds of information.

The communication part T01 is a communication interface such as a network card for connection to the network NW. The communication part T01 communicates with the power transaction matching apparatus 1 via the network NW. The communication part T01 may also communicate with the power generation system G via the network NW.

The display unit T02 displays various kinds of information relating to the trading of electric power in the power transaction matching system S. The display unit T02 is, for example, a Liquid Crystal Display (LCD), an organic Electro Luminescence (EL) display, or the like. The display unit T02 displays images generated by the controller T04, a Graphical User Interface (GUI) for receiving various input operations from the user U, and the like.

The input interface T03 receives various input operations from the user U, converts received input operations into electrical signals, and outputs the electric signals to the controller T04. The input interface T03 includes, for example, a touch panel, a keyboard, a mouse, and the like.

The controller T04 controls the overall operation of the terminal device T. The controller T04 realizes various functions for using the power transaction service by executing, for example, a power transaction application AP for performing a power transaction, which is stored in the storage part T05. The controller T04 realizes, for example, an input function for inputting (setting) a power sale request, a power purchase request, and the like, a management function for managing receiving and giving payment at the time of using the power transaction service, and the like.

The storage part T05 stores various kinds of information relating to DR. The storage part T05 is realized by, for example, semiconductor memory elements such as a Read Only Memory (ROM), a Random Access Memory (RAM), an Electrically Erasable Programmable Read Only Memory (EEPROM), and a flash memory, a storage device (a storage device including a non-transitory storage medium) such as a hard disk drive (HDD), or the like. The storage part T05 stores, for example, the power transaction application AP that is executed in the terminal device T in order to use the power transaction service and the like.

### Configuration of Power Transaction Matching Apparatus

Referring back to FIG. 1, details of the configuration of the power transaction matching apparatus 1 are described. The power transaction matching apparatus 1 includes, for example, a communication part 10, a storage part 20, and a controller 30.

The communication part 10 is a communication interface such as a network card for connection to the network NW. The communication part 10 communicates with the terminal device T via the network NW. The communication part 10 may also communicate with the power generation system G via the network NW. The communication part 10 receives information such as user information transmitted from the terminal device T, power sale request information, power purchase request information, and the like via the network NW and outputs the received information to the controller 30. Communication between the communication part 10 and the terminal device T is wireless communication.

The storage part 20 stores various kinds of information necessary for using the power transaction service. The storage part 20 is realized by, for example, a semiconductor memory element such as a ROM, a RAM, an EEPROM, and a flash memory, a storage device such as a hard disk drive (HDD) (a storage device including a non-transitory storage medium), or the like. The storage part 20 may be realized by another storage device connected via the network NW such as an external storage server apparatus. In the storage part 20, for example, user information D1, power sale request information D2, power purchase request information D3, trading actual result information D4, and the like are stored. The user information D1 is information relating to users U who use the power transaction service. The power sale request information D2 is information of power sale requests in the trading of electric power. The power purchase request information D3 is information of power purchase requests in the trading of electric power. The trading actual result information D4 is information relating to actual results of trading of electric power (that is, the usage history of the power transaction service) in each user U.

The controller 30 controls the overall operation of the power transaction matching apparatus 1. The controller 30 includes, for example, a user information acquisition part 310, a power sale information acquisition part 320, a power purchase information acquisition part 330, a matching candidate search part 340, an achievement level calculation part 350, a display controller 360, a trade request reception part 370, and a trading processing part 380.

Each of the user information acquisition part 310, the power sale information acquisition part 320, the power purchase information acquisition part 330, the matching candidate search part 340, the achievement level calculation part 350, the display controller 360, the trade request reception part 370, and the trading processing part 380 is realized, for example, by a hardware processor (computer) such as a Central Processing Unit (CPU) executing a program (software). Some or all of these components may be realized by hardware (a circuit unit; including circuitry) such as a Large Scale Integration (LSI), a System On Chip (SoC), an application-specific integrated circuit (ASIC), a programmable logic device (for example, a simple programmable logic device (SPLD), a complex programmable logic device (CPLD), or a field programmable gate array (FPGA)), a Graphics Processing Unit (GPU), or the like, or may be realized by software and hardware in cooperation. Some or all of these components may be realized by a dedicated LSI. The program, for example, may be stored in advance in a semiconductor memory element such as a ROM, a RAM, an EEPROM, or a flash memory or a storage device such as a hard disk drive (HDD) (a storage device including a non-transitory storage medium), or may be stored in a loadable/unloadable storage medium (a non-transitory storage medium) such as a DVD or a CD-ROM and installed in a storage device by loading the storage medium into a drive device.

The power transaction matching apparatus 1 is not limited to a single apparatus, and a plurality of apparatuses may be configured to cooperate to realize each functional component of the controller 30. In other words, some or all of the functional components included in the controller 30 provided in the power transaction matching apparatus 1 may be included in other apparatuses. For example, each functional component of the controller 30 may be realized by other apparatuses (a server apparatus and the like) and the power transaction matching apparatus 1 communicating and cooperating with each other.

The user information acquisition part 310 acquires user information transmitted by the terminal device T via the network NW and output by the communication part 10. The user information acquisition part 310 registers the acquired user information in the user information D1 stored in the storage part 20.

The power sale information acquisition part 320 acquires power sale request information transmitted by the terminal device T via the network NW and output by the communication part 10. The power sale information acquisition part 320 registers the acquired power sale request information in the power sale request information D2 stored in the storage part 20. At this time, the power sale information acquisition part 320 determines whether or not the acquired power sale request information is from a user U registered in the user information D1 stored in the storage part 20 and, in a case in which the information is from a user U registered in the user information D1, registers the information in the power sale request information D2 stored in the storage part 20 with a user ID and a terminal device ID of the user U (that is, the power selling-side user U) associated with the acquired power sale request information. Then, the power sale information acquisition part 320 notifies the matching candidate search part 340 that there has been a power sale request from the power selling-side user U.

The power sale information acquisition part 320 is an example of “first information acquisition part.”

The power purchase information acquisition part 330 acquires power purchase request information that has been transmitted by the terminal device T via the network NW and output by the communication part 10. The power purchase information acquisition part 330 registers the acquired power purchase request information in the power purchase request information D3 stored in the storage part 20. At this time, the power purchase information acquisition part 330 determines whether or not the acquired power purchase request information is from a user U registered in the user information D1 stored in the storage part 20 and, in a case in which the information is from a user U registered in the user information D1, registers the information in the power purchase request information D3 stored in the storage part 20 with a user ID and a terminal device ID of the user U (that is, the power buying-side user U) associated with the acquired power purchase request information. Then, the power purchase information acquisition part 330 notifies the matching candidate search part 340 that there has been a power purchase request from the power buying-side user U.

The power purchase information acquisition part 330 is an example of “second information acquisition part.”

When a notification from the power sale information acquisition part 320 or a notification from the power purchase information acquisition part 330 is received, the matching candidate search part 340 starts matching processing according to the received notification (hereinafter referred to as a “matching process”). More specifically, when it is notified that there has been a power sale request from the power sale information acquisition part 320, the matching candidate search part 340 searches a power purchase request of a candidate matching the notified power sale request from the power selling-side user U among the power purchase request information D3 stored in the storage part 20. The matching candidate search part 340 outputs the power sale request information and the power purchase request information of the retrieved power purchase request of the candidate to the achievement level calculation part 350. At this time, in a case in which a plurality of power purchase requests of candidates that match the power sale request have been retrieved, the matching candidate search part 340 outputs information of the plurality of power purchase requests retrieved as candidates to the achievement level calculation part 350. On the other hand, when it is notified that there has been a power purchase request from the power purchase information acquisition part 330, the matching candidate search part 340 searches for a power sale request of a candidate that matches the notified power purchase request from the power buying-side user U in the power sale request information D2 stored in the storage part 20. The matching candidate search part 340 outputs the power purchase request information and the power sale request information of the power sale request of the candidate that has been retrieved to the achievement level calculation part 350. At this time, in a case in which a plurality of power sale requests of candidates that match the power purchase request have been retrieved, the matching candidate search part 340 outputs the information of the plurality of power sale requests retrieved as candidates to the achievement level calculation part 350.

The matching candidate search part 340 searches for a power purchase request of a candidate or a power sale request of candidate, for example, on the basis of the degree of matching between trading conditions included in the power purchase request and the power sale request. More specifically, in each request, the matching candidate search part 340 searches, for example, requests of which the item of the time period in the trading conditions corresponds to the same time period as requests of candidates. The method of searching power purchase requests of candidates or power sale request of candidates in the matching candidate search part 340 is not limited to a method performed on the basis of the degree of matching between trading conditions included in respective requests, and any method may be used as long as it is capable of searching power purchase requests of candidates or power sale requests of candidates.

The matching candidate search part 340 is an example of a “search part.”

The achievement level calculation part 350 calculates an achievement level of a power purchase request represented by power purchase request information for a power sale request represented by the power sale request information output by the matching candidate search part 340 or an achievement level of a power sale request represented by power sale request information for a power purchase request represented by the power purchase request information. At this time, the achievement level calculation part 350 calculates an achievement level for each of the items of the trading conditions included in each request, that is, items of the time period, the amount of electric power, and the price.

More specifically, in a case in which a power sale request is submitted by a power selling-side user U, the achievement level calculation part 350 calculates an achievement level SA(E) of the power amount for a power sale request in a power purchase request retrieved as a candidate matching this power sale request using the following Equation (1) and calculates an achievement level of the price SA(P) using the following Equation (2). On the other hand, in a case in which a power purchase request is submitted from a power buying-side user U, the achievement level calculation part 350 calculates an achievement level BA(E) of the electric power amount for the power purchase request in the power sale request retrieved as a candidate matching this power purchase request using the following Equation (3) and calculates an achievement level BA(P) of price using the following Equation (4).

$$SA ( E ) = ( BmaxE - SminE ) / ( SmaxE - SminE ) \qquad ( 1 )$$

$$SA ( P ) = ( BmaxP - SminP ) / ( SmaxP - SminP ) \qquad ( 2 )$$

$$BA ( E ) = ( SmaxE - BminE ) / ( BmaxE - BminE ) \qquad ( 3 )$$

$$BA ( P ) = ( BmaxP - SminP ) / ( BmaxP - BminP ) \qquad ( 4 )$$

In Equations (1) and (3) presented above, BmaxE represents an upper limit value of the desired power purchase amount, BminE represents a lower limit value of the desired power purchase amount, SmaxE represents an upper limit value of the sellable power amount, and SminE represents a lower limit value of the sellable power amount. In Equations (2) and (4), BmaxP represents an upper limit value of a desired power purchase price, BminP represents a lower limit value of the desired power purchase price, SminP represents a lower limit value of the sellable power price, and SmaxP represents an upper limit value of the sellable power price.

In Equations (1) and (3) represented above, while the order of the first term and the second term in the numerator on the right side is equivalent, in Equations (2) and (4) represented above, the order of the first term and the second term in the numerator on the right side is reversed. The reason for this is that, relating to the power amount, both the power selling-side user U and the power buying-side user U being closer to the upper limit value of the power amount (that is, having a larger power amount) is benefitable, and, relating to the price, the power selling-side user U being closer to the upper limit value of the price (that is, having a higher price) is benefitable, and the power buying-side user U being closer to the lower limit value (that is, having a lower price) is benefitable.

The achievement level (SA(E)) calculated using Equation (1) represented above is an example of a “first achievement level,” and the achievement level (SA(P)) calculated using Equation (2) represented above is an example of a “second achievement level.” The achievement level (BA(E)) calculated using Equation (3) represented above is an example of a “third achievement level,” and the achievement level (BA(P)) calculated using Equation (4) represented above is an example of a “fourth achievement level.”

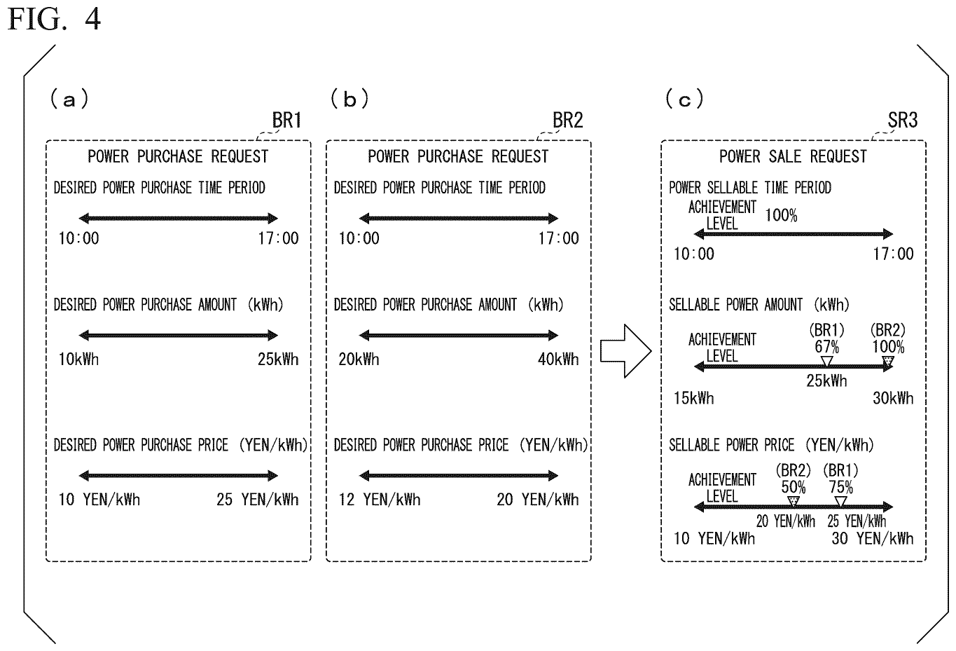

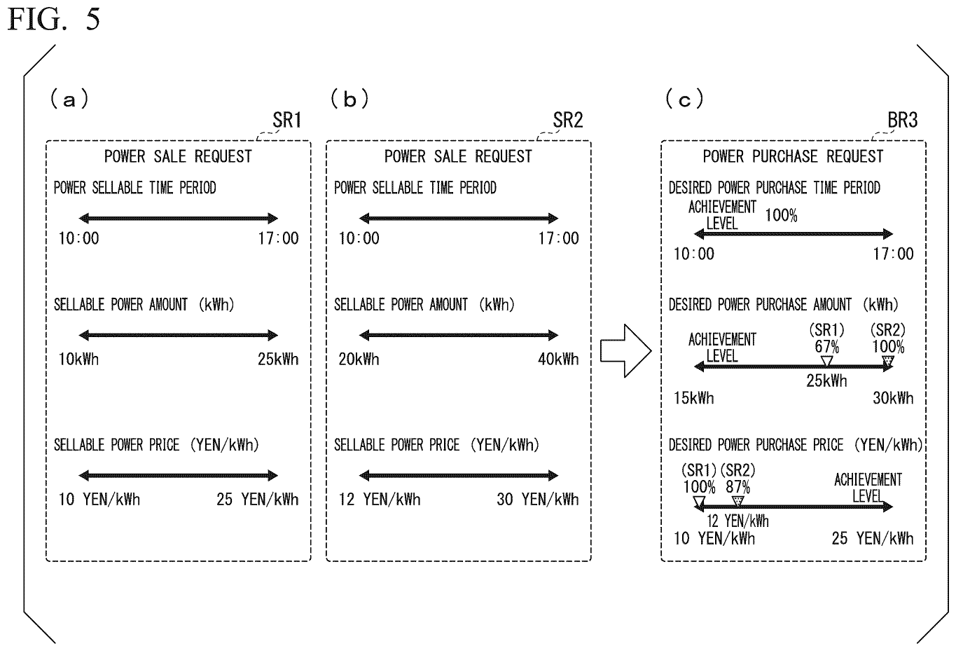

Here, an example of calculation of the achievement level in the achievement level calculation part 350 is described. FIG. 4 is a diagram schematically illustrating example of a case in which an achievement level for a power sale request is calculated in the power transaction matching apparatus 1 (more specifically, the achievement level calculation part 350) according to the embodiment. FIG. 5 is a diagram schematically illustrating examples of a case in which an achievement level for a power purchase request is calculated in the power transaction matching apparatus 1 (more specifically, the achievement level calculation part 350) according to the embodiment.

First, a case in which the achievement level calculation part 350 calculates an achievement level for a power sale request is described with reference to FIG. 4. The example illustrated in FIG. 4 is a example in which, in a case in which a power sale request SR3 as illustrated in part (c) of FIG. 4 has been submitted from a power selling-side user U (for example, a user U3), the matching candidate search part 340 has retrieved a power purchase request BR1 illustrated in part (a) of FIG. 4 (for example, a request submitted by a user U1 as a power purchasing-side user U) and a power purchase request BR2 illustrated in part (b) of FIG. 4 as power purchase requests of candidates matching this power sale request SR3 (for example, a request submitted by the user U2 as a power purchasing-side user U). In this case, the achievement level calculation part 350 calculates an achievement level for each of items included in the power sale request SR3.

In the examples illustrated in FIG. 4, in each of the power sale request SR3, the power purchase request BR1, and the power purchase request BR2, the items of time periods are all “10:00” to “17:00”, and thus the achievement level for the time period is “100%”. On the other hand, regarding the power amount of the examples illustrated in FIG. 4, a sellable power amount is “15 (kWh)” to “30 (kWh)” in the power sale request SR3, a desired power purchasing amount is “10 (kWh)” to “25 (kWh)” in the power purchase request BR1, and a desired power purchasing amount is “20 (kWh)” to “40 (kWh)” in the power purchase request BR2. For this reason, by using Equation (1) represented above, the achievement level calculation part 350 calculates an achievement level SA(E) of the power amount for the power sale request SR3 in each of the power purchase request BR1 and the power purchase request BR2. More specifically, the achievement level calculation part 350 calculates the achievement level SA(E)_BR1 of the power amount for the power sale request SR3 in the power purchase request BR1 as in the following Equation (5) and calculates the achievement level SA(E)_BR2 of the power amount for the power sale request SR3 in the power purchase request BR2 as in the following Equation (6). However, while the upper limit value of the sellable power amount in the power sale request SR3 is “30 (kWh)”, the upper limit value of the desired power purchase amount in the power purchase request BR2 is “40 (kWh)”, which exceeds the upper limit value of the sellable power amount. For this reason, the achievement level calculation part 350 regards the upper limit value of the desired power purchase amount as “30 (kWh)” and substitutes the upper limit value therewith and calculates the achievement level SA(E)_BR2 of electric power as in the following Equation (6).

$$SA ( E ) \_BR1 = ( 25 - 15 ) / ( 30 - 15 ) = 67 \% \qquad ( 5 )$$

$$SA ( E ) \_BR2 = ( 30 - 15 ) / ( 30 - 15 ) = 1 \; 00 \% \qquad ( 6 )$$

Furthermore, relating to the price in the examples illustrated in FIG. 4, while the sellable price is “10 (yen/kWh)” to “30 (yen/kWh)” in the power sale request SR3, the desired power purchase price is “10 (yen/kWh)” to “25 (yen/kWh)” in the power purchase request BR1, and the desired power purchase price is “12 (yen/kWh)” to “20 (yen/kWh)” in the power purchase request BR2. For this reason, by using Equation (2) represented above, the achievement level calculation part 350 calculates an achievement level of the price SA(P) for the power sale request SR3 in each of the power purchase request BR1 and the power purchase request BR2. More specifically, the achievement level calculation part 350 calculates an achievement level of the price SA(P)_BR1 for the power sale request SR3 in the power purchase request BR1 as in the following Equation (7) and calculates an achievement level of the price SA(P)_BR2 for the power sale request SR3 in the power purchase request BR2 as in the following Equation (8).

$$SA ( P ) \_BR1 = ( 25 - 10 ) / ( 30 - 10 ) = 75 \% \qquad ( 7 )$$

$$SA ( P ) \_BR2 = ( 20 - 10 ) / ( 30 - 10 ) = 50 \% \qquad ( 8 )$$

Subsequently, a case in which the achievement level calculation part 350 calculates an achievement level for a power purchase request is described with reference to FIG. 5. The examples illustrated in FIG. 5 are examples of a case in which, when a power purchase request BR3 illustrated in part (c) of FIG. 5 is submitted from a power purchasing-side user U (for example, a user U3), the matching candidate search part 340 retrieves a power sale request SR1 illustrated in part (a) of FIG. 5 (for example, submitted by the user U1 as a power selling-side user U) and a power sale request SR2 illustrated in part (b) of FIG. 5 (for example, submitted by the user U2 as a power selling-side user U) as power sale requests of candidates matching this power purchase request BR3. In this case, the achievement level calculation part 350 calculates the achievement level for each of items included in the power purchase request BR3.

In the examples illustrated in FIG. 5, in each of the power purchase request BR3, the power sale request SR1, and the power sale request SR2, since the item of the time period is “10:00” to “17:00”, the achievement level for the time period is “100%”. On the other hand, regarding the power amount of the examples illustrated in FIG. 5, while a desired power purchase amount is “15 (kWh)” to “30 (kWh)” in the power purchase request BR3, a sellable power amount is “10 (kWh)” to “25 (kWh)” in the power sale request SR1, and a sellable power amount is “20 (kWh)” to “40 (kWh)” in the power sale request SR2. For this reason, by using Equation (3) represented above, the achievement level calculation part 350 calculates an achievement level of electric power BA(E) for the power purchase request BR3 in each of the power sale request SR1 and the power sale request SR2. More specifically, the achievement level calculation part 350 calculates an achievement level BA(E)_SR1 of the power amount for the power purchase request BR3 in the power sale request SR1 as in the following Equation (9) and calculates an achievement level BA(E)_SR2 of the power amount for the power purchase request BR3 in the power sale request SR2 as in the following Equation (10). However, while the upper limit value of the desired power purchase amount in the power purchase request BR3 is “30 (kWh)”, the upper limit value of the sellable power amount in the power sale request SR2 is “40 (kWh)”, which exceeds the upper limit value of the desired power purchase amount. For this reason, the achievement level calculation part 350 replaces the upper limit value of the sellable power amount with “30 (kWh)” and calculates an achievement level BA(E)_SR2 of the power amount as in the following Equation (10).

$$BA ( E ) \_SR1 = ( 25 - 15 ) / ( 30 - 15 ) = 67 \% \qquad ( 9 )$$

$$BA ( E ) \_SR2 = ( 30 - 15 ) / ( 30 - 15 ) = 100 \% \qquad ( 10 )$$

Furthermore, regarding the price in the examples illustrated in FIG. 5, while the desired power purchase price is “10 (yen/kWh)” to “25 (yen/kWh)” in the power purchase request BR3, the sellable power price is “10 (yen/kWh)” to “25 (yen/kWh)” in the power sale request SR1, and the sellable power price is “12 (yen/kWh)” to “30 (yen/kWh)” in the power sale request SR2. For this reason, by using Equation (4) representaed above, the achievement level calculation part 350 calculates an achievement level BA(P) of the power price for the power purchase request BR3 in each of the power sale request SR1 and the power sale request SR2. More specifically, the achievement level calculation part 350 calculates an achievement level BA(P)_SR1 of the price for the power purchase request BR3 for the power sale request SR1 as in the following Equation (11) and calculates an achievement level BA(P)_SR2 of the price for the power purchase request BR3 for the power sale request SR2 as in the following Equation (12).

$$BA ( P ) \_SR1 = ( 25 - 10 ) / ( 25 - 10 ) = 100 \% \qquad ( 11 )$$

$$BA ( P ) \_SR2 = ( 25 - 12 ) / ( 25 - 10 ) = 87 \% \qquad ( 12 )$$

In the examples illustrated in FIG. 4 and FIG. 5, although a case in which the achievement level of the time period is “100%” in accordance with the items of the time period being all the same time period in the respective requests is illustrated, in a case in which the time periods are different from each other, the achievement level calculation part 350 calculates an achievement level also for the item of the time period. In this case, the method for calculating the achievement level may be equivalent to that of the above-described examples and can be easily conceived from the examples described above. Accordingly, a detailed description of the method for calculating an achievement level of the time period using the achievement level calculation part 350 in a case in which time periods are different from each other is omitted.

Referring back to FIG. 1, on the basis of the achievement levels calculated in this way, the achievement level calculation part 350 ranks the achievement levels of the respective requests, which have been retrieved as candidates by the matching candidate search part 340, in descending order of the value, in other words, performs ranking. At this time, the achievement level calculation part 350 acquires a sum value of the calculated achievement levels for each request retrieved as a candidate by the matching candidate search part 340 and ranks the requests in descending order of the sum value.

However, in a case in which the item of “priority order” is selected (designated) in the power sale request or the power purchase request, the achievement level calculation part 350 further calculates achievement levels in accordance with the priority order desired by the user U on the basis of weighting coefficients corresponding to the selected item of “priority order” and then ranks the achievement levels of the respective requests. More specifically, the achievement level calculation part 350 calculates a final achievement level in accordance with weights of the priority order desired by the user U by multiplying each calculated achievement level by the weighting coefficient corresponding to the selected item of “priority order”. Then, the achievement level calculation part 350 acquires a sum value of the calculated final achievement levels for each request and ranks the final achievement levels of the respective requests in descending order of the sum value.

Here, the weighting coefficients corresponding to the item of “priority order” by which the achievement levels calculated by the achievement level calculation part 350 are multiplied are set in advance for each item of the priority order. In a case in which the item of “priority order” can be selected (designated) by one of the buttons as in the examples illustrated in FIG. 2, a corresponding weighting coefficient is set for each of the buttons. More specifically, for a “Power amount (high)” button, for example, a weighting coefficient of 0.8 is set such that the weight of the power amount is 80%, and a weighting coefficient of 0.2 is set such that the weight of the price is 20%. For a “Power amount (low)” button, for example, a weighting coefficient of 0.6 is set such that the weight of the power amount is 60%, and a weighting coefficient of 0.4 is set such that the weight of the price is 40%. For a “Price (high)” button, for example, a weighting coefficient of 0.2 is set such that the weight of the power amount is 20%, and a weighting coefficient of 0.8 is set such that the weight of the price is 80%. For a “Price (low)” button, for example, a weighting coefficient of 0.4 is set such that the weight of the power amount is 40%, and a weighting coefficient of 0.6 is set such that the weight of the price is 60%. For a “Power amount/price balance” button, for example, a weighting coefficient of 0.5 is set such that the weight of the power amount is 50%, and a weighting coefficient of 0.5 is set such that the weight of the price is 50%. The achievement level calculation part 350 calculates the final achievement level in accordance with the weight according to the priority order desired by the user U by multiplying each calculated achievement level by the weighting coefficient corresponding to the selected button.

For example, in the examples illustrated in FIG. 4, a final achievement level SA_BR1 of the power purchase request BR1 and a final achievement level SA_BR2 of the power purchase request BR2 for the power sale request SR3 are calculated as represented in the following Equation (13) in a case in which the “Power amount (high)” button is selected, are calculated as represented in the following Equation (14) in a case in which the “Power amount (low)” button is selected, are calculated as represented in the following Equation (15) in a case in which the “Price (high)” button is selected, are calculated as represented in the following Equation (16) in a case in which the “Price (low)” button is selected, and are calculated as represented in the following Equation (17) in a case in which the “Power amount/price balance” button is selected.

$$SA \_BR1 = 67 \% \times 0.8 + 75 \% \times 0.2 = 68.6 \%$$

$$SA \_BR2 = 100 \% \times 0.8 + 50 \% \times 0.2 = 90. \% \qquad ( 13 )$$

$$SA \_BR1 = 67 \% \times 0.6 + 75 \% \times 0.4 = 70.2 \%$$

$$SA \_BR2 = 100 \% \times 0.6 + 50 \% \times 0.4 = 80. \% \qquad ( 14 )$$

$$SA \_BR1 = 67 \% \times 0.2 + 75 \% \times 0.8 = 73.4 \%$$

$$SA \_BR2 = 100 \% \times 0.2 + 50 \% \times 0.8 = 60. \% \qquad ( 15 )$$

$$SA \_BR1 = 67 \% \times 0.4 + 75 \% \times 0.6 = 71.8 \%$$

$$SA \_BR2 = 100 \% \times 0.4 + 50 \% \times 0.6 = 70. \% \qquad ( 16 )$$

$$SA \_BR1 = 67 \% \times 0.5 + 75 \% \times 0.5 = 71. \%$$

$$SA \_BR2 = 100 \% \times 0.5 + 50 \% \times 0.5 = 75. \% \qquad ( 17 )$$

For example, in the examples illustrated in FIG. 5, a final achievement level BA_SR1 of the power sale request SR1 and a final achievement level BA_SR2 of the power sale request SR2 for the power purchase request BR3 are calculated as represented in the following Equation (18) in a case in which the “Power amount (high)” button is selected, are calculated as represented in the following Equation (19) in a case in which the “Power amount (low)” button is selected, are calculated as represented in the following Equation (20) in a case in which the “Price (high)” button is selected, are calculated as represented in the following Equation (21) in a case in which the “Price (low)” button is selected, and are calculated as represented in the following Equation (22) in a case in which the “Power amount/price balance” button is selected.

$$BA \_SR1 = 67 \% \times 0.8 + 100 \% \times 0.2 = 73.6 \%$$

$$BA \_SR2 = 100 \% \times 0.8 + 87 \% \times 0.2 = 97.4 \% \qquad ( 18 )$$

$$BA \_SR1 = 67 \% \times 0.6 + 100 \% \times 0.4 = 80.2 \%$$

$$BA \_SR2 = 100 \% \times 0.6 + 87 \% \times 0.4 = 94.8 \% \qquad ( 19 )$$

$$BA \_SR1 = 67 \% \times 0.2 + 100 \% \times 0.8 = 93.4 \%$$

$$BA \_SR2 = 100 \% \times 0.2 + 87 \% \times 0.8 = 89.6 \% \qquad ( 20 )$$

$$BA \_SR1 = 67 \% \times 0.4 + 100 \% \times 0.6 = 86.8 \%$$

$$BA \_SR2 = 100 \% \times 0.4 + 87 \% \times 0.6 = 92.2 \% \qquad ( 21 )$$

$$BA \_SR1 = 67 \% \times 0.5 + 100 \% \times 0.5 = 83.5 \%$$

$$BA \_SR2 = 100 \% \times 0.5 + 87 \% \times 0.5 = 93.5 \% \qquad ( 22 )$$

On the basis of the final achievement levels calculated in this way, the achievement level calculation part 350 ranks the final achievement levels of the respective requests that have been retrieved as candidates by the matching candidate search part 340. In the examples illustrated in FIG. 4, in a case in which the “Power amount (high)” button or the “Power amount (low)” button is selected, in other words, in a case in which the priority of the power amount is higher than that of the price, the power purchase request BR2 is ranked higher. In the examples illustrated in FIG. 4, in a case in which the “Price (high)” button or the “Price (low)” button is selected, in other words, in a case in which the priority of the price is higher than that of the power amount, the power purchase request BR1 is ranked higher. In the examples illustrated in FIG. 4, in a case in which the “Power amount/price balance” button is selected, the power purchase request BR2 is ranked higher. In the examples illustrated in FIG. 5, in a case in which the “Power amount (high)” button or the “Power amount (low)” button is selected (in other words, in a case in which the priority of the power amount is higher than that of the price), the power sale request SR2 is ranked higher. In the examples illustrated in FIG. 5, in a case in which the “Price (high)” button is selected, in other words, in a case in which the priority of the power amount is high, the power sale request SR1 is ranked higher, and in a case in which the “Price (low)” button is selected, in other words, in a case in which the priority of the power amount is slightly high (preferentially prioritized as much as possible), the power sale request SR2 is ranked higher. In the examples illustrated in FIG. 5, in a case in which the “Power amount/price balance” button is selected, the power sale request SR2 is ranked higher.

The achievement level calculation part 350 outputs the information of the respective calculated achievement levels and the ranking information to the display controller 360 together with the power sale request information and the power purchase request information output by the matching candidate search part 340.

The achievement level calculation part 350 is an example of a “calculation part”.

The display controller 360 performs control for displaying information on a display device of the terminal device T. On the basis of respective pieces of the information output by the achievement level calculation part 350 (the information of the achievement levels, the information of the ranking, and the information of each request), the display controller 360 generates notification information for notifying the user U of matching candidates and outputs the generated notification information to the communication part 10 to cause the notification information to be transmitted to a corresponding terminal device T via the network NW. The matching candidates may be, for example, a request having the highest ranking recommended to the user U or a predetermined number of requests selected from a request having the highest ranking. The notification information may be an image to be displayed on the display device by the power transaction application being executed on the terminal device T (for example, an image equivalent to the power sale request SR3 illustrated in part (c) of FIG. 4 or the power purchase request BR3 illustrated in part (c) of FIG. 5) as notification information (for example, the information of the achievement level, the information of the ranking, the information of each request, and a request to be recommended which are presented to the user U) or may be information for generating an image to be displayed on the display device by the power transaction application. The notification information includes the power sale request information or the power purchase request information having the highest ranking and the information of achievement level thereof, that is, information of the item of “priority order” selected (designated) by the user U. The configuration is not limited thereto, and the notification information may include all ranked power sale request information or power purchase request information, and achievement level information for each of the requests, that is, information of the item of “priority order” not selected (designated) by the user U in addition to the information of the item of “priority order” selected (designated) by the user U. In this case, when notifying the user U of matching candidates, the display controller 360 may notify the user U of the information of the item of “priority order” selected (designated) by the user U. For example, the display controller 360 may notify the user U of information of the item of “priority order” initially selected (designated) by the user U and thereafter, in a case in which the user U selects (designates) another item of “priority order”, may notify the user U of information of the other item of “priority order” corresponding to the selection (designation) made by the user U.

In accordance with this, the user U can check the notification information displayed on the display device of the terminal device T and select a request for actually requesting the trading of electric power. The user U's selection of a request for actually requesting the trading of electric power is also input by performing an operation on the power transaction application. The power transaction application transmits information of the request for actually requesting the trading of electric power, which has been input (selected), to the power transaction matching apparatus 1 via the network NW. The information of the request for requesting the trading of electric power (hereinafter simply referred to as a “trading request”) includes power sale request information or power purchase request information for actually requesting the trading of electric power.

The notification information is an example of “matching result”.

The trade request reception part 370 receives a trade request transmitted from the terminal device T via the network NW and output by the communication part 10. When the trade request reception part 370 receives a trade request from the terminal device T, the power transaction matching apparatus 1 notifies a terminal device T (hereinafter, referred to as “terminal device TB” to distinguish from the terminal device T used by the user U requesting the trade) used by a user U, who is a trading partner of electric power, represented in the power sale request information or the power purchase request information included in the trade request (hereinafter referred to as “user UB” to distinguish from the user U requesting the trade) of the presence of the trade request from the user U.

Thereafter, when the user UB who has received the notification of the presence of the trade request approves the trading of electric power with the user U, ac power transaction using a power transaction service, that is, trading of electric power is performed between the user U and the user UB. At this time, the trade request reception part 370 transmits matching information used for performing trading of electric power (power transaction) between the user U and the user UB to each of the terminal device T used by the user U and the terminal device TB used by the user UB, thereby causing actual trading of electric power to be started. Since the method of trading electric power between users U in the power transaction matching system S is similar to existing methods for trading electric power, a detailed description of the method of trading electric power is omitted.

The trade request reception part 370 is an example of a “reception part”. The trade request is an example of a “matching request.”

The trading processing part 380 manages actual results of trading of electric power between users U. More specifically, the trading processing part 380 registers information representing that electric power has been traded between a user U and a user UB in the trading actual result information D4 stored in the storage part 20 in association with the respective user IDs of the user U and the user UB and terminal device IDs (which may be user information D1). The trading actual result information D4 may include, for example, information representing a time period (it may include a date or a period) during which electric power was traded, and information representing the power amount, the price, and the like is registered as a result of trading of electric power. The trading processing part 380 may control the processing of trading of electric power between users U in the electric power transaction service of the power transaction matching system S and may also manage the receiving and making payment at the time of trading electric power using the electric power transaction service.

### Flow of Overall Process in Power Transaction Matching Apparatus

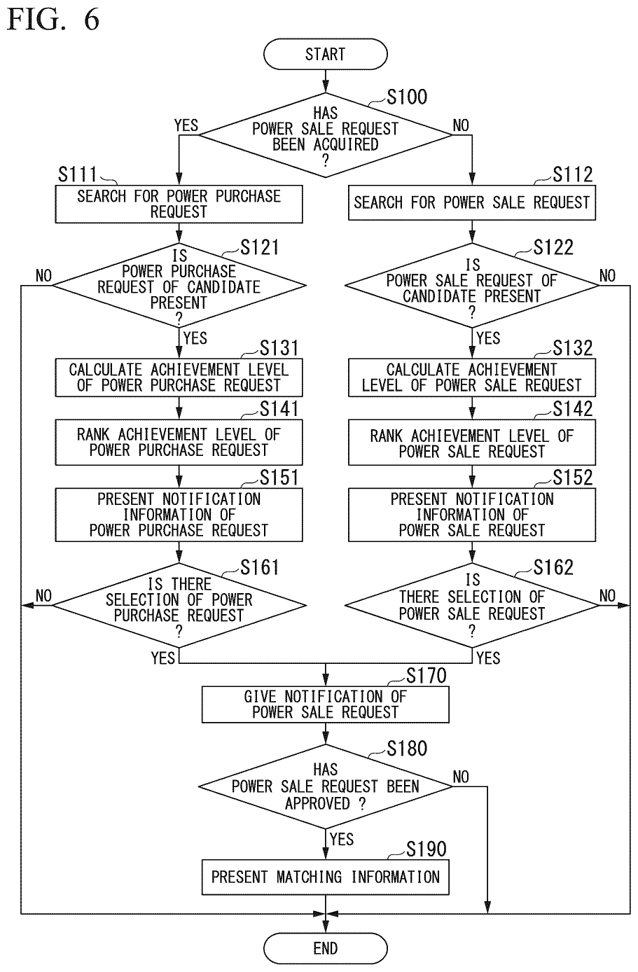

Next, an example of the matching process in the power transaction matching apparatus 1 is described. FIG. 6 is a flowchart illustrating an example of a flow of a matching process in the power transaction matching apparatus 1 according to the embodiment.

In the following description, it is assumed that the user information acquisition part 310 has already acquired user information and registered user information D1, the power sale information acquisition part 320 has acquired power sale request information and registered power sale request information D2, and the power purchase information acquisition part 330 has acquired power purchase request information and registered power purchase request information D3 (stored in the storage part 20).

As described above, the matching process illustrated in FIG. 6 is started when the matching candidate search part 340 receives a notification from the power sale information acquisition part 320 or the power purchase information acquisition part 330. When the matching processing is started, first, the matching candidate search part 340 determines whether or not the received notification is a notification indicating that the power sale information acquisition part 320 has acquired a power sale request (Step S100).

In Step S100, when it is checked in Step S100 that the received notification is a notification indicating that the power sale information acquisition part 320 has acquired a power sale request, the matching candidate search part 340 searches for power purchase requests in the power purchase request information D3 stored in the storage part 20 (Step S111). Then, the matching candidate search part 340 determines whether or not there is a power purchase request of a candidate matching the power sale request from the power selling-side user U, which has been notified, among retrieved power purchase requests (Step S121). In a case in which it is determined in Step S121 that there is no power purchase request of a candidate matching the power sale request, the matching candidate search part 340 ends the matching process of this time.

On the other hand, in a case in which it is determined in Step S121 that there is a power purchase request of a candidate matching the power sale request, the matching candidate search part 340 outputs the power sale request information of the power sale request from the power selling-side user U, which has been notified, and the power purchase request information of the power purchase request of the candidate that has been retrieved to the achievement level calculation part 350.

Subsequently, the achievement level calculation part 350 calculates an achievement level of the power purchase request on the basis of the power sale request information and the power purchase request information output by the matching candidate search part 340 (Step S131). More specifically, the achievement level calculation part 350 calculates an achievement level for each item of the power purchase request represented by the power purchase request information for the power sale request represented by the power sale request information (see the example of calculation of an achievement level in a case in which a power sale request has been acquired illustrated in FIG. 4). In a case in which the item of “priority order” is selected (designated) in the power sale request, the achievement level calculation part 350 calculates a final achievement level on the basis of the item of “priority order” selected (designated) in the power sale request.

Subsequently, the achievement level calculation part 350 ranks the achievement levels of the power purchase requests on the basis of the calculated achievement levels (they may be the final achievement levels) (Step S141). Then, the achievement level calculation part 350 outputs information of the calculated achievement levels of the respective power purchase requests and information indicating the ranking of the power purchase requests to the display controller 360 together with the power sale request information and the power purchase request information output by the matching candidate search part 340.

Subsequently, the display controller 360 generates notification information used for notifying the user U of power purchase requests of matching candidates on the basis of respective pieces of information output by the achievement level calculation part 350 and presents the notification information to the user U (Step S151). Here, as described above, the presentation of the notification information to the user U is performed by the display controller 360 outputting the generated notification information to the communication part 10, the communication part 10 transmitting the notification information to a corresponding terminal device T via the network NW, and an electric power transaction application provided in the corresponding terminal device T displaying an image on the display device (display unit T02).

Thereafter, the trade request reception part 370 checks whether or not a power purchase request for actually requesting the trading of electric power has been selected by the power selling-side user U (Step S161). The checking of whether or not the power purchase request has been selected in Step S161, for example, can be performed by checking whether or not the trade request reception part 370 has received a trade request from the power selling-side user U, in other words, whether or not a trade request has been transmitted from the terminal device T used by the power selling-side user U. In a case in which it is checked in Step S161 that no power purchase request has been selected by the power selling-side user U, the trade request reception part 370 ends the matching process of this time.

On the other hand, in a case in which it is checked in Step S161 that a power purchase request has been selected by the power selling-side user U, the trade request reception part 370 causes the process to proceed to Step S170.

On the other hand, in a case in which it is checked in Step S100 that the received notification is not a notification indicating that the power sale information acquisition part 320 has acquired a power sale request, that is, indicating that the power purchase information acquisition part 330 has acquired a power purchase request, the matching candidate search part 340 searches for power sale requests in the power sale request information D2 stored in the storage part 20 (Step S112). Then, the matching candidate search part 340 determines whether or not there is a power sale request of a candidate matching the power purchase request from the power purchasing-side user U, which has been notified, among retrieved power sale requests (Step S122). In a case in which it is determined in Step S122 that there is no power sale request of a candidate matching the power purchase request, the matching candidate search part 340 ends the matching process of this time.

On the other hand, in a case in which it is determined in Step S122 that there is a power sale request of a candidate matching the power purchase request, the matching candidate search part 340 outputs the power purchase request information of the power purchase request from the power purchasing-side user U, which has been notified, and the power sale request information of the power sale request of the candidate, which has been retrieved, to the achievement level calculation part 350.

Subsequently, the achievement level calculation part 350 calculates an achievement level of the power sale request on the basis of the power purchase request information and the power sale request information output by the matching candidate search part 340 (Step S132). More specifically, the achievement level calculation part 350 calculates an achievement level for each item of the power sale request represented by the power sale request information for the power purchase request represented by the power purchase request information (see the examples of the calculation of achievement levels in a case in which a power purchase request is acquired, illustrated in FIG. 5). In a case in which the item of “priority order” is selected (designated) in the power purchase request, the achievement level calculation part 350 calculates a final achievement level on the basis of the item of “priority order” selected (designated) in the power purchase request.

Subsequently, the achievement level calculation part 350 ranks achievement levels of the power sale requests on the basis of the calculated achievement levels (they may be the final achievement levels) (Step S142). Then, the achievement level calculation part 350 outputs information of the calculated achievement levels of the respective power sale requests and information indicating the ranking of the power sale requests to the display controller 360 together with the power purchase request information and the power sale request information output by the matching candidate search part 340.

Subsequently, the display controller 360 generates notification information used for notifying the user U of power sale requests of candidates matching on the basis of respective pieces of information output by the achievement level calculation part 350 and presents the notification information to the user U (Step S152). As described above, the presentation of the notification information to the user U here is performed by the display controller 360 outputting the generated notification information to the communication part 10, the communication part 10 transmitting the notification information to a corresponding terminal device T via the network NW, and an electric power transaction application provided in the corresponding terminal device T displaying an image on a display device (display unit T02).

Thereafter, the trade request reception part 370 checks whether or not a power sale request for actually requesting trading of electric power has been selected by the power purchasing-side user U (Step S162). The checking of whether or not a power sale request has been selected in Step S162 can be performed, for example, by the trade request reception part 370 checking whether or not a trade request from the power purchasing-side user U has been received, in other words, whether or not a trade request has been transmitted from the terminal device T used by the power purchasing-side user U. In a case in which it is checked in Step S162 that no power sale request has been selected by the power purchasing-side user U, the trade request reception part 370 ends the matching process of this time.

On the other hand, in a case in which it is checked in Step S162 that a power sale request has been selected by the power purchasing-side user U, the trade request reception part 370 causes the process to proceed to Step S170.

Then, in a case in which it is checked in Step S161 that a power purchase request has been selected by the power selling-side user U, when it is checked that a power sale request has been selected by the user UB, who is a trading partner of electric power represented in the power purchase request information, or the power purchasing-side user U in Step S162, the trade request reception part 370 notifies the user UB, who is a trading partner of electric power represented in the power sale request information, that a trade request has been submitted by the user U (Step S170). Thereafter, the trade request reception part 370 checks whether or not the notified trade request has been approved (Step S180). In a case in which it is checked in Step S180 that the notified trade request has not been approved, the trade request reception part 370 ends the matching process of this time.

On the other hand, in a case in which it is checked in Step S180 that the notified trade request has been approved, the trade request reception part 370 presents matching information used for performing trading of electric power (power transactions) between the user U and the user UB to each of the user U and the user UB (Step S190). In accordance with this, for example, electric power is actually traded between the user U and the user UB via a power transmission path (not illustrated in the drawing).

Thereafter, when the trading of electric power between the user U and the user UB ends, the trading processing part 380 registers actual results of the trading of electric power of this time (the power transaction) in the trading actual result information D4 (stores the results in the storage part 20). Furthermore, the trading processing part 380 performs the process of receiving or making payment for the trading of electric power (power transaction) between the user U and the user UB. At this time, the trading processing part 380 outputs information relating to the receiving and making payment to the communication part 10 and causes the information to be transmitted to each of a terminal device T used by the user U and a terminal device TB used by the user UB. In accordance with this, each of the user U and the user UB can perform the process of receiving and making payment for this trading of electric power (power transaction) using the terminal devices T used by the users. The process of receiving and making payment may be performed by an electric power transaction application executed on each terminal device T.

In accordance with such a configuration and processing (the matching process), the power transaction matching apparatus 1 calculates an achievement level for each trading condition (items such as a time period (it may include a date or a period), a power amount, a price, and the like) included in the respective requests when recommending a power purchase request from another user U that matches a power sale request submitted by the user U or a power sale request from another user U that matches a power purchase request submitted by the user U. Then, the power transaction matching apparatus 1 ranks the calculated achievement levels and recommends requests having higher achievement levels to the user U. In accordance with this, the power transaction matching apparatus 1 can recommend requests that better satisfy the request submitted by the user U to the user U.

Moreover, in the power transaction matching apparatus 1, the user U can designate (set) conditions to be prioritized among the trading conditions as “priority order.” Then, the power transaction matching apparatus 1 calculates a final achievement level by multiplying the calculated achievement level by a weighting coefficient corresponding to the item designated (set) as the “priority order,” ranks the calculated final achievement levels, and recommends requests having higher achievement levels to the user U. Accordingly, the power transaction matching apparatus 1 can recommend, to the user U, requests in which the trading conditions prioritized by the user U more closely match the user's desire.

As described above, according to the power transaction matching apparatus 1 of the embodiment, in a case in which a power sale request is submitted by a power selling-side user U, a search for power purchase requests of candidates matching the power sale request is performed, and achievement levels for trading conditions included in each power sale request for the trading conditions included in the retrieved power purchase requests are calculated. Then, the power transaction matching apparatus 1 of the embodiment ranks the calculated achievement levels and presents power purchase requests having higher achievement levels to the power selling-side user U as power purchase requests to be recommended when the trading of electric power represented in the power sale request is performed. In accordance with this, the power transaction matching apparatus 1 of the embodiment can recommend power purchase requests having higher achievement levels of the trading conditions of electric power (power sellable conditions) represented in the power sale request, that is, power purchase requests that more closely match the desire of the power selling-side user U to the power selling-side user U. In other words, the power transaction matching apparatus 1 of the embodiment can recommend power purchase requests in which various conditions including reasons, purposes, and the like, for which the power selling-side user U desires to sell electric power, are sufficiently reflected to the power selling-side user U.

On the other hand, according to the power transaction matching apparatus 1 of the embodiment, in a case in which a power purchase request is submitted by a power purchasing-side user U, a search for candidate power sale requests that match the power purchase request is performed, and achievement levels for trading conditions included in each power purchase request for trading conditions included in the retrieved power sale requests are calculated. Then, the power transaction matching apparatus 1 of the embodiment ranks the calculated achievement levels and presents power sale requests having higher achievement levels to the power purchasing-side user U as power sale requests to be recommended when the trading of electric power represented in the power purchase request is performed. In accordance with this, the power transaction matching apparatus 1 of the embodiment can recommend power sale requests having higher achievement levels for the trading conditions of electric power (desired power purchase conditions) represented in the power purchase request, that is, power sale requests that more closely match the desire of the power purchasing-side user U to the power purchasing-side user U. In other words, the power transaction matching apparatus 1 of the embodiment can recommend power sale requests in which various conditions including reasons, purposes, and the like, for which the power purchasing-side user U desires to purchase electric power, are sufficiently reflected to the power-purchasing-side user U.

Moreover, in the power transaction matching apparatus 1 of the embodiment, the user U (the power selling-side user U or the power purchasing-side user U) can designate (set) a condition to be prioritized among the trading conditions as “priority order.” Then, in the power transaction matching apparatus 1 of the embodiment, a final achievement level is calculated by multiplying the calculated achievement level by a weighting coefficient corresponding to the item designated (set) as the “priority order,” the calculated final achievement levels are ranked, and requests (power purchase requests or power sale requests) having higher achievement levels are recommended to the user U. In accordance with this, the power transaction matching apparatus 1 of the embodiment can recommend requests (power purchase requests or power sale requests) in which the trading conditions prioritized by the user U (the power selling-side user U or the power purchasing-side user U) more closely match the user's desire to the user U.

As a result, in the power transaction matching apparatus 1 of the embodiment, when the user U (the power selling-side user U or the power purchasing-side user U) trades electric power between individuals, it is possible to enable the user U to find (select) a user U who is a more appropriate trading partner (more specifically, a power purchasing-side user U who is a trading partner of the power selling-side user U, and a power selling-side user U who is a trading partner of the power purchasing-side user U).

The embodiment described above can be expressed as below.

A computer of a power transaction matching apparatus matching power transactions among a plurality of power systems that individually generate and/or consume electric power includes a storage medium storing computer-readable instructions and a processor connected to the storage medium, the power transaction matching apparatus is configured such that the processor executes the computer-readable instructions to: acquire power sale requests from power selling-side power systems; acquire power purchase requests from power purchasing-side power systems; and calculate achievement levels of trading conditions for electric power to be traded on the basis of power sellable conditions that are trading conditions of the power sale requests and desired power purchase conditions that are trading conditions of the power purchase requests.

In the above-described embodiment, a case in which the power transaction matching apparatus 1 performs power transactions between power generation systems G installed at individual residences H (more specifically, between storage batteries that store electric power generated by the power generation systems G) has been described as “the trading of electric power performed between users U.” However, as described above, the power transaction matching system S may include one or more vehicles M (more specifically, storage batteries (batteries B) mounted on the vehicles M) as components. For this reason, in the power transaction service in the power transaction matching system S including the power transaction matching apparatus 1, either one or both of a power sale request and a power purchase request may be requests for trading of electric power (power transaction) by discharging or charging the battery B mounted on the vehicle M. In this case, the configuration, the operation, and the matching process of the power transaction matching apparatus 1 may be configured to be equivalent to the configuration, the operation, and the matching process of the power transaction matching apparatus 1 described in the embodiments.

Although the embodiment for carrying out the present invention has been described above, the present invention is not limited to such an embodiment at all, and various modifications and substitutions may be made in the range not departing from the concept of the present invention.

What is claimed is;

1. A power transaction matching apparatus matching power transactions between a plurality of power systems individually generating and/or consuming electric power, the power transaction matching apparatus comprising:
a first information acquisition part acquiring power sale requests from the power systems of a power selling-side;
a second information acquisition part acquiring power purchase requests from the power systems of a power purchasing-side; and
a calculation part calculating achievement levels of trading conditions for electric power to be traded on the basis of power sellable conditions, which are trading conditions of the power sale request, and desired power purchase conditions, which are trading conditions of the power purchase request.

2. The power transaction matching apparatus according to claim 1,
wherein the power sellable conditions include, at least, trading conditions for each of items including a power sellable time period that is an item of a time period, a sellable power amount that is an item of a power amount, and a power sellable price that is an item of a price,
wherein the desired power purchase conditions include, at least, the trading conditions of each of items including a desired power purchase time period that is an item of a time period, a desired power purchase amount that is an item of a power amount, and a desired power purchase price that is an item of a price, and
wherein the calculation part calculates the achievement level for each of the items of the trading conditions and presents a sum value of the achievement levels of each of the items as a matching result.

3. The power transaction matching apparatus according to claim 2, further comprising a search part searching for candidates matching the power sale request and the power purchase request,
wherein the calculation part presents the matching result between the retrieved power sale request and the power purchase request.

4. The power transaction matching apparatus according to claim 3,
wherein, in a case in which the matching result representing the power purchase request to be recommended for the power sale request is presented, the calculation part calculates a first achievement level that is an achievement level of the sellable power amount with respect to an upper limit value of the desired power purchase amount and a second achievement level that is an achievement level of the sellable power price with respect to an upper limit value of the desired power purchase price and presents the power purchase request for which a sum value of the first achievement level and the second achievement level is high as the matching result, and in a case in which the matching result representing the power sale request to be recommended for the power purchase request is presented, the calculation part calculates a third achievement level that is an achievement level of the desired power purchase amount with respect to an upper limit value of the sellable power amount and a fourth achievement level that is an achievement level of the sellable power price with respect to an upper limit value of the desired power purchase price and presents the power sale request for which a sum value of the third achievement level and the fourth achievement level is high as the matching result.

5. The power transaction matching apparatus according to claim 4,
wherein either one or both of the power sellable conditions and the desired power purchase conditions further include priority order conditions for each of the items of the trading conditions, and
wherein the calculation part calculates a final achievement level for each of the items by multiplying the calculated achievement level of each of the items of the trading conditions by a weighting coefficient that is set in advance for the priority order conditions and presents the power sale request and the power purchase request for which a sum value of the final achievement levels of each of the items is high as the matching result.

6. The power transaction matching apparatus according to claim 5, wherein the priority order conditions include at least one of a first condition prioritizing the item of the power amount, a second condition prioritizing the item of the price, and a third condition prioritizing a balance between the item of the power amount and the item of the price.

7. The power transaction matching apparatus according to claim 6,
wherein the first condition includes a 1-1 condition in which the priority of the item of the power amount is higher and a 1-2 condition in which the priority of the item of the power amount is high, and
wherein the second condition includes a 2-1 condition in which the priority of the item of the price is higher and a 2-2 condition in which the priority of the item of the price is high.

8. The power transaction matching apparatus according to claim 7, wherein the priority order conditions further include a fourth condition of an origin of electric power to be traded.

9. The power transaction matching apparatus according to claim 8, wherein the priority order conditions further include a fifth condition relating to a payment method in a power transaction.

10. The power transaction matching apparatus according to claim 1, further comprising a reception part receiving a matching request between the power sale request and the power purchase for which the sum value of the achievement levels has been presented as the matching result,
wherein the reception part performs requested matching between the power sale request and the power purchase request in accordance with the received matching request.

11. A power transaction matching system that matches power transactions between a plurality of power systems individually generating and/or consuming electric power, the power transaction matching system comprising:
a power transaction matching apparatus including: a first information acquisition part acquiring power sale requests from the power systems of a power selling-side; a second information acquisition part acquiring power purchase requests from the power systems of a power purchasing-side; and a calculation part calculating achievement levels of trading conditions for electric power to be traded on the basis of power sellable conditions, which are trading conditions of the power sale request, and desired power purchase conditions, which are trading conditions of the power purchase request; and
a plurality of request devices corresponding to each of the power systems and transmitting the power sale request or the power purchase request to the power transaction matching apparatus.

12. The power transaction matching system according to claim 11, wherein one or more of the plurality of power systems are batteries mounted on vehicles.

13. A power transaction matching method of a power transaction matching apparatus matching power transactions between a plurality of power systems individually generating and/or consuming electric power, the power transaction matching method using a computer of the power transaction matching apparatus comprising:
acquiring power sale requests from the power systems of a power selling-side;
acquiring power purchase requests from the power systems of a power purchasing-side; and
calculating achievement levels of trading conditions for electric power to be traded on the basis of power sellable conditions, which are trading conditions of the power sale request, and desired power purchase conditions, which are trading conditions of the power purchase request.
